(19) United States
(12) Patent Application Publication
(10) Pub. No.: US 2020/0405063 A1
(43) Pub. Date: Dec. 31, 2020

(54) Collapsible Cart with Adjustable Seat

(71) Applicant: James Alton Bulger, Bainbridge, GA (US)

(72) Inventor: James Alton Bulger, Bainbridge, GA (US)

(21) Appl. No.: 16/845,023

(22) Filed: Apr. 9, 2020

Related U.S. Application Data
(60) Provisional application No. 62/831,609, filed on Apr. 9, 2019.

(51) Int. Cl. A47C 13/00; B62B 1/26; B62B 5/06; A47C 4/44

(52) U.S. Cl. CPC A47C 13/00; B62B 1/26; B62B 2203/00; A47C 4/44; B62B 2206/006; B62B 5/06

(57) ABSTRACT

A collapsible cart with adjustable seat designed for folding, portable transport, sitting, or reclining purposes. The said cart features a U-shaped removable U shape axle with wheels attached. The cart accommodates a removable basket, and the cart includes an upright or reclining adjustable seat. The cart is transportable for use in camping, hunting and other outdoors activities.

### PRIORITY CLAIM

This application claims benefit of U.S. Provisional Patent Application No. 62/831,609 filed on Apr. 9, 2019.

### FIELD OF THE INVENTION

The invention relates to a collapsible cart and particularly to a collapsible cart with an adjustable seat for sitting or lying down that is attached to a metal frame featuring a single removable axle with two wheels, a removable basket, and storage compartments used to transport beach, lake, river, camping and tailgating accessories.

### BACKGROUND OF THE INVENTION

Beach, lake, river goers, campers, outdoorsmen, and tailgating enthusiasts all have one thing in common, they all are overloaded with physically carrying too many accessories to their final destination. Therefore, a need exists for a way for these persons to carry items by a convenient means and have a comfortable way to sit or lie when recreating. Thus, the invention provides a collapsible cart and adjustable seat with storage capabilities.

### SUMMARY OF THE INVENTION

The collapsible cart and adjustable seat of the present invention allows those same beach, lake, river goers, campers, outdoorsmen, and tailgating enthusiasts the advantage of transporting their accessories on a multi-function metal frame supported by two wheels. They can simply push or pull the unit, to their desired location via a detachable or retractable handle. Upon arrival, the unit is deployed into an upright position, where an adjustable backrest of the seat with quick drying fabric is available for sitting purposes. At this time, Additional accessories include but are not limited to: a neck pillow, soft side cooler, vinyl cooler, hard cooler, detachable pouch, large adjustable accessory pouch on the backrest of the seat cover, detachable multi-purpose bag, adjustable canopy, camera mount, removable platform/accessory tray, and Bluetooth speakers. The unit also includes a water bottle holder and cell phone holder, which can be inserted into an open slot in each wooden arm rest, and locked underneath by a clip, to keep them from falling off during transportation of the unit to and from a selected destination.

The collapsible cart with adjustable seat designed for sitting or reclining purposes features a removable axle with wheels attached. The removable axle incorporates a U-shape bend through the mid-portion of the axle length. The basket pivotally attaches to the seat frame and floats in place while supporting items during transport via the cart.

In one object of the invention, a user can convert the portable cart to various uses including transport of a cooler and seating in a beach going environment.

In another object of the invention, a user may fold the portable cart and transport the cart by hand, carry the cart in a bag, or transport the cart in a vehicle, such as a canoe or boat.

In another object, a cart transports a cooler via a basket pivotally attached to the frame of the cart behind a backrest.

In another object a backrest of the adjustable seat leans backward until flat and permits a person to lie comfortably on the seat in a prone position.

In another object the axle and wheels detach for disassembly and carrying the collapsible cart.

In another object, the basket detaches and converts into a side table for the adjustable seat.

The invention includes these and other objects within the scope of the specification and claims that follow.

### BRIEF DESCRIPTION OF THE DRAWINGS

FIG. 1 is a perspective view of a collapsible cart with adjustable seat in accordance with an embodiment of the invention in a folded position without a canopy.

FIG. 2 is a perspective view of the invention showing an embodiment of the frame for the seat.

FIG. 3 is a perspective view of the invention showing an embodiment of the frame for the seat.

FIG. 4 is a perspective view of the invention showing an embodiment with the seat upright and canopy opened.

FIG. 5 is a side view of the invention showing an embodiment with the seat upright and canopy opened.

FIG. 6 is a perspective view of the invention showing an embodiment with the seat upright and canopy opened.

FIG. 7 is a side view of the invention showing an embodiment with the seat and canopy folded.

FIG. 8 is a perspective view of the invention showing an embodiment with the seat upright and canopy opened.

FIG. 9 is a side view of the invention showing an embodiment with the seat upright and canopy opened.

FIG. 10 is a side view of the invention showing an embodiment with the seat upright and canopy opened.

FIG. 11 is a side view of the invention showing an embodiment with the seat upright and canopy opened.

FIG. 12 is a side view of the invention showing an embodiment with the seat upright and canopy opened.

FIG. 13 is a perspective view of the invention showing an embodiment with the apparatus collapsed.

FIG. 14 is a side view of the invention showing an embodiment with the apparatus collapsed.

FIG. 15 is a perspective view of the invention showing an embodiment with the seat upright and canopy opening, further including a basket attached to the seat frame behind the seat and a container attached to the seat frame behind the backrest.

FIG. 16a is a perspective view showing a collapsed covering frame for the covering portion of the apparatus.

FIG. 16b is a perspective view showing the collapsed frame for the seat portion of the apparatus.

FIG. 16c is a perspective view showing the axle portion of the apparatus for attachment to the frame for the seat portion.

FIG. 16d is a perspective view showing the nuts for attachment of the wheels to the axle portion of the apparatus.

FIG. 16e is a perspective view showing the wheels for attachment to the axle portion of the apparatus.

FIG. 16f is a perspective view showing the wire object holders of the apparatus.

FIG. 16g is a perspective view showing the basket of the apparatus.

FIG. 17a is a perspective view showing the basket of the apparatus with legs folded outward from the basket for conversion of the basket to a side table.

FIG. 17b is a side view of the basket in FIG. 17a.

FIG. 17c is a top view of the basket in FIG. 17a.

### DETAILED DESCRIPTION

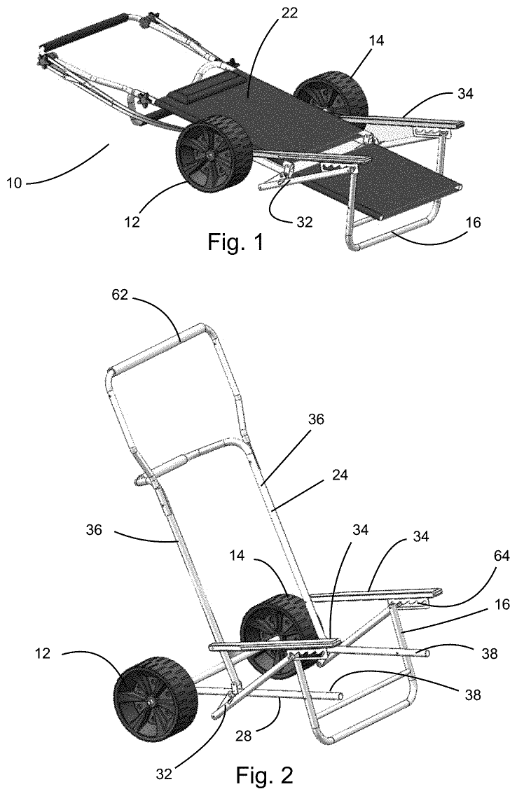

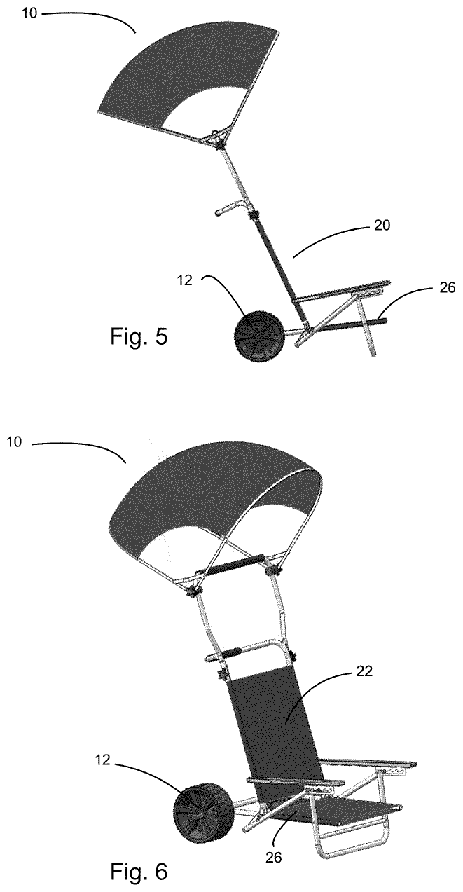

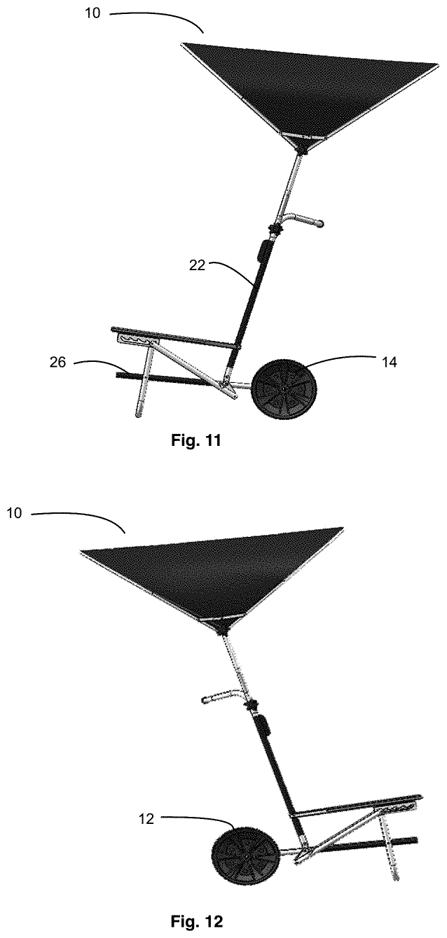

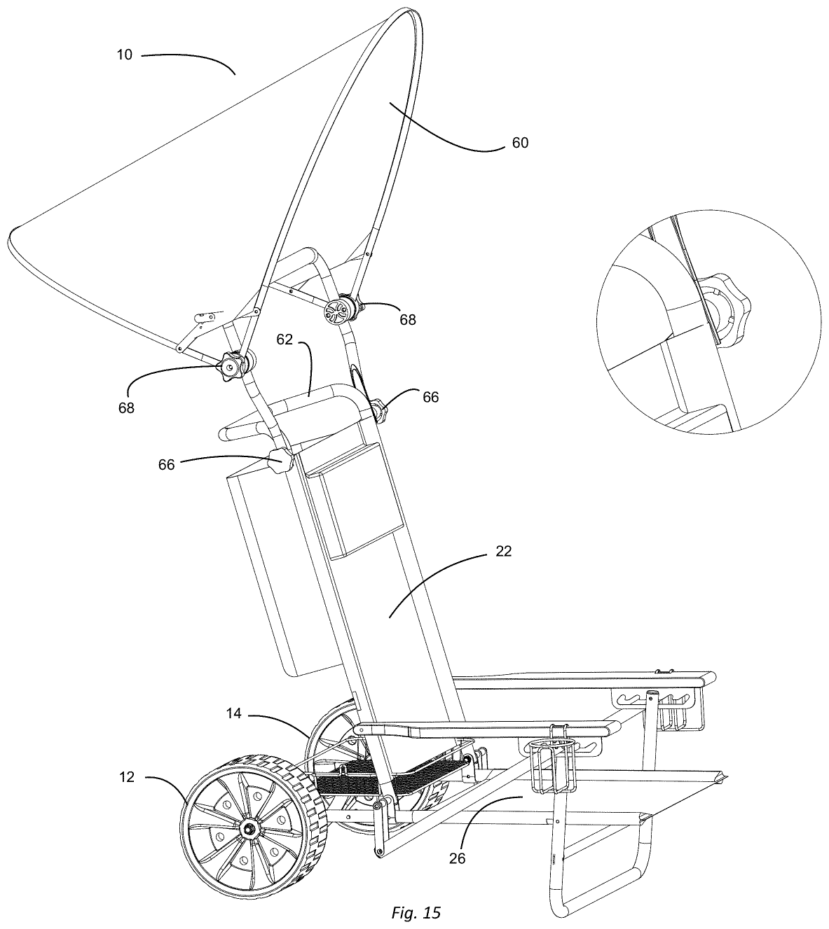

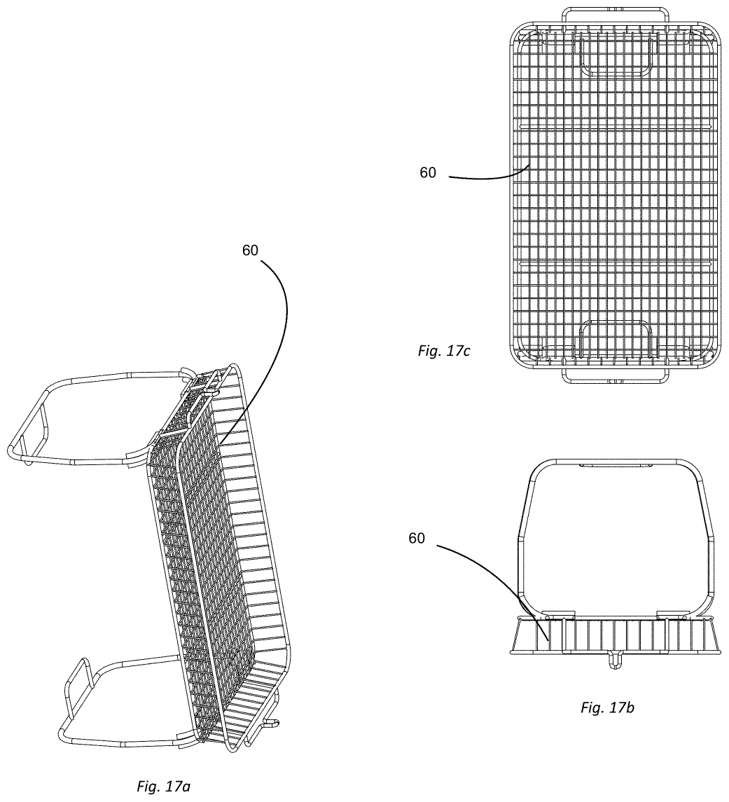

As shown in the drawing FIGS. 1-17c, the present invention is directed to collapsible cart 10 with wheels 12, 14 combined with an adjustable seat 20, for carrying on a beach, in a boat etc. The adjustable seat 20 can also function as an armchair for sitting or a recliner chair for lying down. The adjustable seat includes a backrest 22 supported by an upper frame 24 and a seat 26 supported by a lower frame 28. The apparatus features a removable axle 40 with U-shaped mid-section 42 for accommodating the backrest 22 of the adjustable seat in reclined position. The apparatus further features a removable basket 60 designed to pivotally attach on the sides of the basket to the adjustable seat and float in place on the lower frame 28. The basket removes from the adjustable seat and includes folding legs that fold down and convert the basket into a side table as shown in FIGS. 17a-17c.

FIG. 1 shows cart 1 in an assembled position with a pair of wheels, a pair of arm rests and a pair of legs for support. The left wheel 12 and right wheel 14 secure to the removable axle 40 that is removably mounted on the rear end portion of the lower frame 28. The cart of the present invention comprises a metal frame that has two portions, upper frame 24 portion supporting the backrest and lower frame 28 portion supporting the seat, basket, and axle. The two portions are pivotally connected via brackets 30 with links 32 pivotally connected to the arms 34 to form an integral unit while in use.

As shown in FIG. 2, the cart of the present invention is made up of a metal frame or structural frame. As shown in FIG. 2, the backrest portion comprising the upper frame 24 is made up of two upper frame rods 36 which are pivotally connected at the lower portion of the upper frame to the lower frame 28. The lower frame 28 is made of two elongated lower frame rods 38 which are connected to the axle, from the arms of the cart via the upper frame rods and bracket, and from the arms via connection to front legs 16.

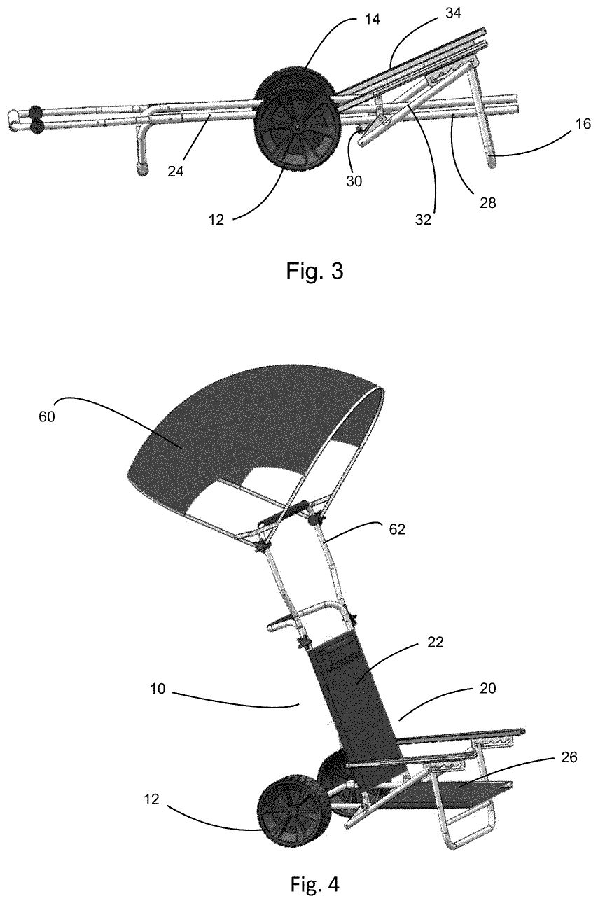

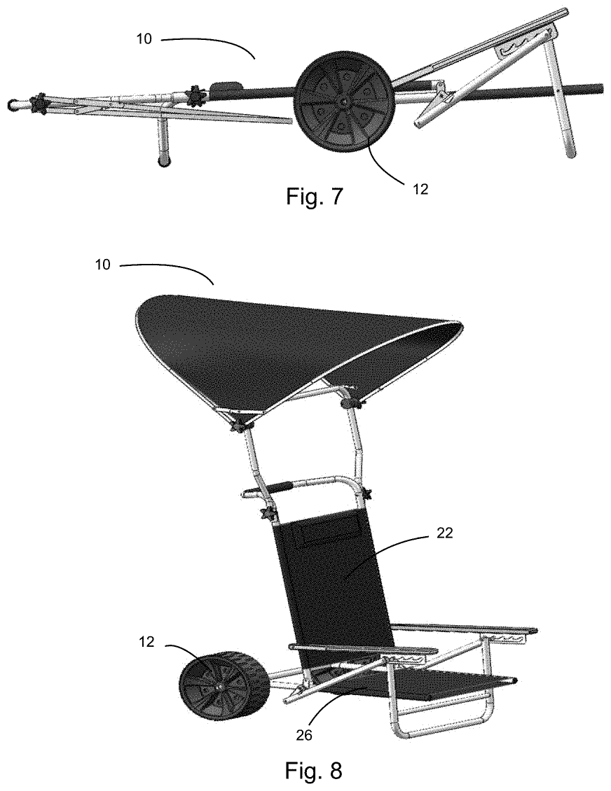

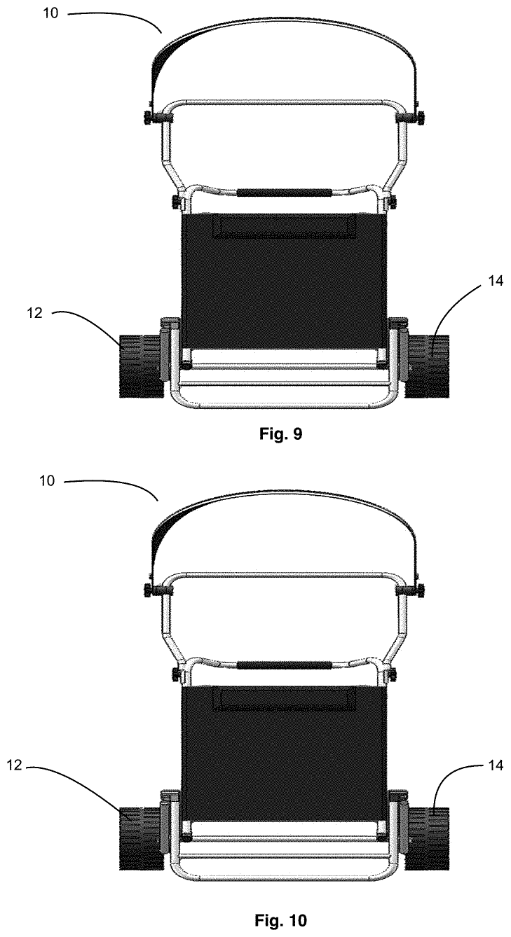

Front legs 16 are in U-shape to give support to the cart when in use. The said legs are pivotally connected to the said arms 34 and the lower frame rods 38. As shown in FIG. 3, the lower portion of the frame is connected pivotally with hinges to the arms of the cart. FIGS. 4-6 and 8 shows a possible embodiment, when in use, of the present invention wherein the canopy is mounted on the handle and the cart is in the form of a chair to rest. FIG. 7 shows an elongated horizontal view of the present invention where the cart is in compact position. FIG. 9-12 shows a front view of the embodiment of the present invention when use as an armchair with canopy.

The collapsible cart folds down for packaging and transportation purposes. Elastic loops on each arm rest hold the arms firmly in place and will not allow the chair to fold upwards or downwards while the unit is being pulled or pushed. Removing these elastic loops, allows the cart to fold into place for sitting or lying purposes. When fully upright, there are two slotted locking braces, one on each side of the arm rest attached to the frame. These slotted braces allow the unit to fold forwards and backwards to a desired position.

Refer to FIG. 3, the removable handle, which the unit is pulled or pushed with, pivots by loosening two (2) plastic knobs, one (1) on each side of the handle. Loosening the knobs and pivoting the handle downwards towards the bottom of the seat, allows for maximum storage clearance during packaging and transportation of the unit. The unit could also be constructed with a retractable handle, much like the ones used on luggage bags. However, we designed a strong U-shaped handle, which adds more control when pushing or pulling the unit through mud or sand. Each vertical side of the U-shaped handle holds an adjustable plastic knob, which is used to support an adjustable canopy.

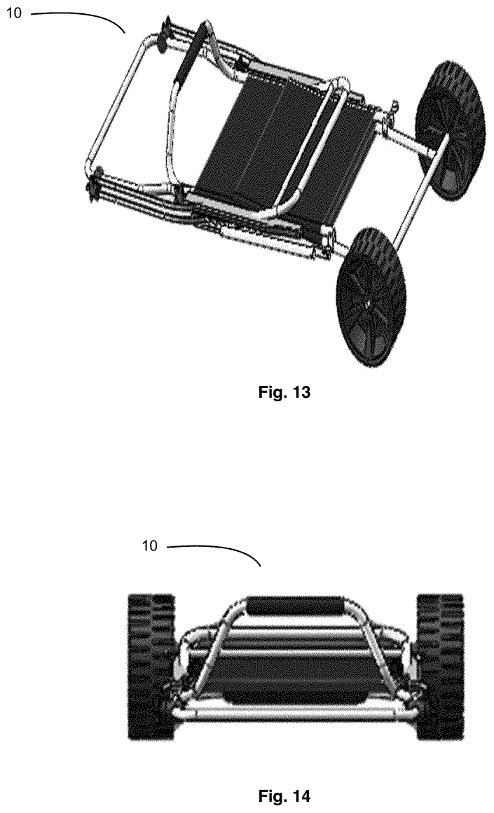

Several aspects of the invention improve usability for outdoors environments and recreation. The canopy is used for shading the sun from individuals, who want limited sun exposure. It can be adjusted to become fully open, or fully closed for transportation, sitting or lying purposes. The wide plastic tires are used for added stability during transportation to and from sandy, muddy, marshy, or remote areas. These wide tires also help to stabilize the unit when folded into a vertical or horizontal position, with an individual sitting or lying on the unit. The collapsible cart comes standard with plastic tires. However, the unit can be constructed with solid rubber tires and or air tires. The axle and tires can be detached from the collapsible cart for transportation and packaging purposes, by simply pressing on the spring-loaded button on each side of the lower bottom frame. FIG. 13 and FIG. 14 are showing collapsible position of the said cart. The cart can be collapsed to a compact unit for transportation. Another possible embodiment of the present invention is a recliner chair.

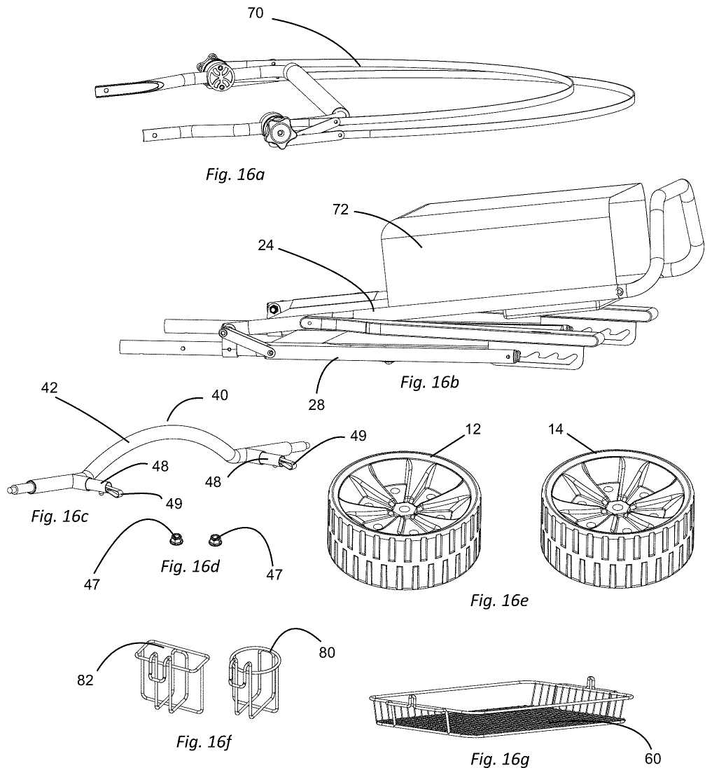

FIGS. 16a-16g illustrate additional features on the invention. The collapsible cart includes a collapsible covering frame as shown in FIG. 16a. The upper frame collapses as shown in FIG. 16b into a folded relation to the lower frame. The upper frame supports a storage container accessory attached to the backrest and a handle for convenient gripping of the cart for movement while rolling the cart or grabbing and lifting the folded collapsed cart. FIG. 16c depicts the details of the removable axle including the U-shaped mid-section between the distal ends, the axial ends for attachment of rolling wheels, and the perpendicularly disposed peg members with spring members for insertion in the lower frame. FIG. 16d shows the cap nuts for attachment of the wheels shown in FIG. 16e. FIG. 16f shows accessory cup holder and mobile device holder for attached to the seat configuration of the collapsible cart, and FIG. 16g shows the basket, which is show in further detail in FIGS. 17a-17c.

The collapsible cart could be designed with one front wheel and two back wheels or, a front axle with two front wheels and back axle, with two back wheels, featuring a total of four wheels for those individuals who desire to push or pull the cart without having to lilt the unit backwards, so the front seat bar doesn't touch the ground during transportation of the unit to and from point A to B. To further add to the design, an electric or gas motor may engage and drive one or more of the wheels to make the apparatus a self-propelled unit during transport as a cart. Steering in the form of a removable steering wheel or one or more hand levers on the unit may attach to the handle of the unit to control the front tire, or tires.

I claim:

1. A collapsible cart comprising:
a structural frame, the frame comprising:
at least two arms attached thereof;
at least one front leg pivotally connected to a first end of the said arms, and a second end of said arms being pivotally connected to said frame;
at least one supporting arm pivotally connected to said frame to support the axle;
at least one wheel rotatably mounted to said axle;
a handle including at least one longitudinal portion, is pivotally connected to said s frame;
at least one front leg pivotally connected to the said arms, while the said arms and said supporting arms are pivotally connected to a rod to make a combination that can be folded such that the handle, front leg and rear leg can be pivotally manipulated to be in close proximity to one other, thereby collapsing into a minimal space for easy and convenient storage and transport and forming an integral unit.

2. The structural frame of claim 1, wherein the structural frame is adapted to support a flexible material to form a chair.

3. The leg attached to the frame of claim 1, wherein the said legs are in U shape to support the frame.

4. The axle of claim 1, wherein the said axle is removable and makes the cart transportable and compact.

5. The wheel of claim 1, wherein the wheels are mounted on the said axle.

6. The collapsible cart of claim 1, wherein the said cart is designed with a basket such that the basket floats in place during transport and holds articles during transport.
